(19) United States
(12) Patent Application Publication
(10) Pub. No.: US 2013/0047769 A1
(43) Pub. Date: Feb. 28, 2013

(54) INDUSTRIAL ROBOT WITH GEAR TRANSMISSION MECHANISM

(71) Applicant: BO LONG, Shenzhen City, Guangdong Province (CN)

(72) Inventor: BO LONG, Shenzhen City, Guangdong Province (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/334,301

(22) Filed: Dec. 22, 2011

(30) Foreign Application Priority Data
Aug. 31, 2011 (CN) 201110255040.7

(51) Int. Cl. B25J 18/00

(52) U.S. Cl. 74/490.01; 901/25

(57) ABSTRACT

An industrial robot with a gear transmission mechanism is disclosed. The industrial robot comprises a base; a robot arm assembly rotatably connected to the base; the robot arm assembly comprising a gear box; a first driving member positioned on the gear box, the first driving member having a first driving shaft; a first transmission mechanism positioned in the gear box, wherein the first transmission mechanism has at least two gears meshing with each other and a fixed shaft fixed to the base, one of the at least two gears is connected to the first driving shaft, and another one of the at least two gears is rotatably sleeved on the fixed shaft, and fixed to the gear box.

### BACKGROUND

1. Technical Field

The present disclosure generally relates to robot technologies, and particularly to an industrial robot with a gear transmission mechanism.

2. Description of the Related Art

Referring to FIG. 4, a six-axis robot 100 is schematically shown. The robot 100 includes a base 11, a bracket 12 rotatably connected to the base 11, a lower arm 13 rotatably connected to the bracket 12, a middle joint 14 connected to the lower arm 13, an upper arm 15 rotatably connected to the middle joint 14 and an end joint 17 rotatably connected to the end of the upper arm 15. The bracket 12, the lower arm 13, the middle joint 14 and the upper arm 15 are respectively capable of rotating about a first axis 161, a second axis 162, a third axis 163 and a fourth axis 164. The end joint 17 includes a fifth shaft (not shown) rotatably connected to the upper arm 15 and a sixth shaft (not shown) rotatably connected to the fifth shaft. The fifth and sixth shafts are respectively capable of rotating about a fifth axis 165 and sixth axis 166. An actuator, such as a cutting tool, a clamping tool or a detector can be mounted on the sixth shaft to perform a predetermined action.

Generally, the robot 100 is provided with an electric motor and a speed reducer (not shown) to drive the upper arm 15. The speed reducer may be a rotary vector (RV) speed reducer or a harmonic drive (HD) speed reducer. However, both the RV speed reducer and the HD speed reducer are expensive. In addition, cables connected to the RV speed reducer or the HD speed reducer for supplying power or control signal directions have to be received inside the upper arm 15, and as a result the cables are vulnerable to damage by abrasion or by being twisted.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of an embodiment of an industrial robot including a first enclosure and a second enclosure.

FIG. 2 is a cross-sectional view of the first enclosure of FIG. 1.

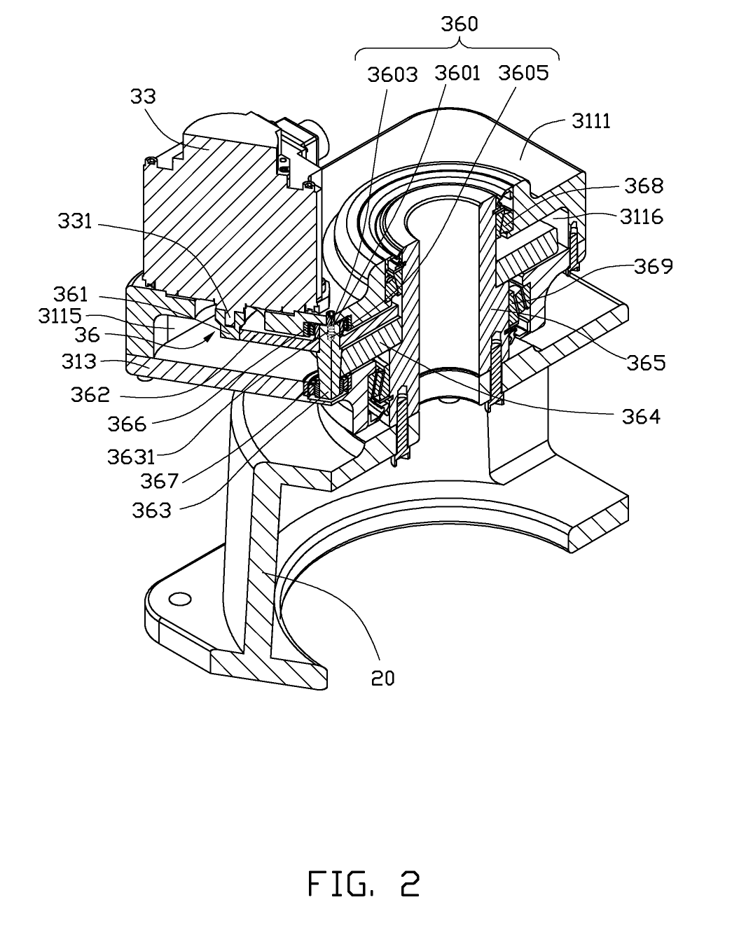

FIG. 3 is a cross-sectional view of the second enclosure of FIG. 1.

FIG. 4 is a schematic view of a related art industrial robot.

### DETAILED DESCRIPTION

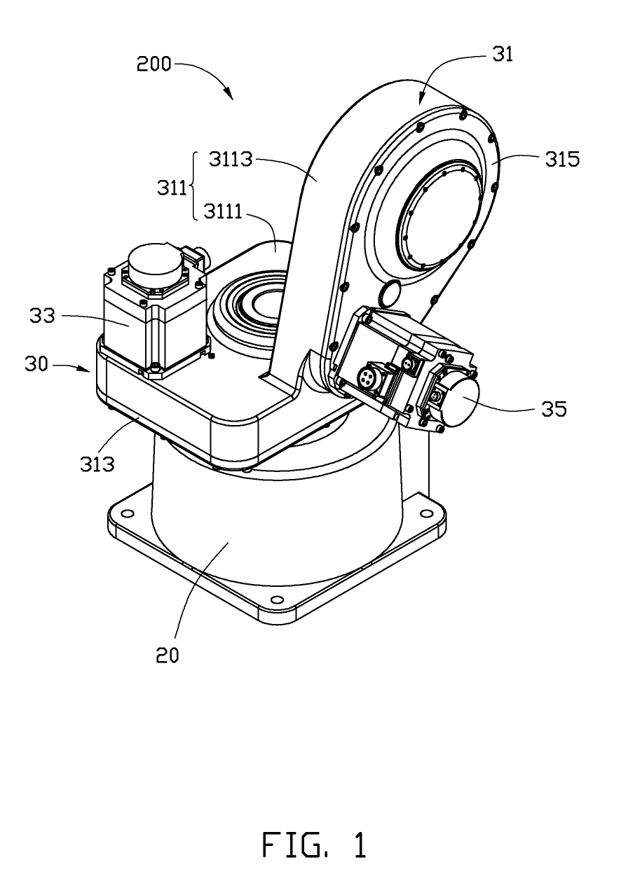

Referring to FIG. 1, an embodiment of an industrial robot 200 comprises a base 20, and a robot arm assembly 30 rotatably connected to the base 20.

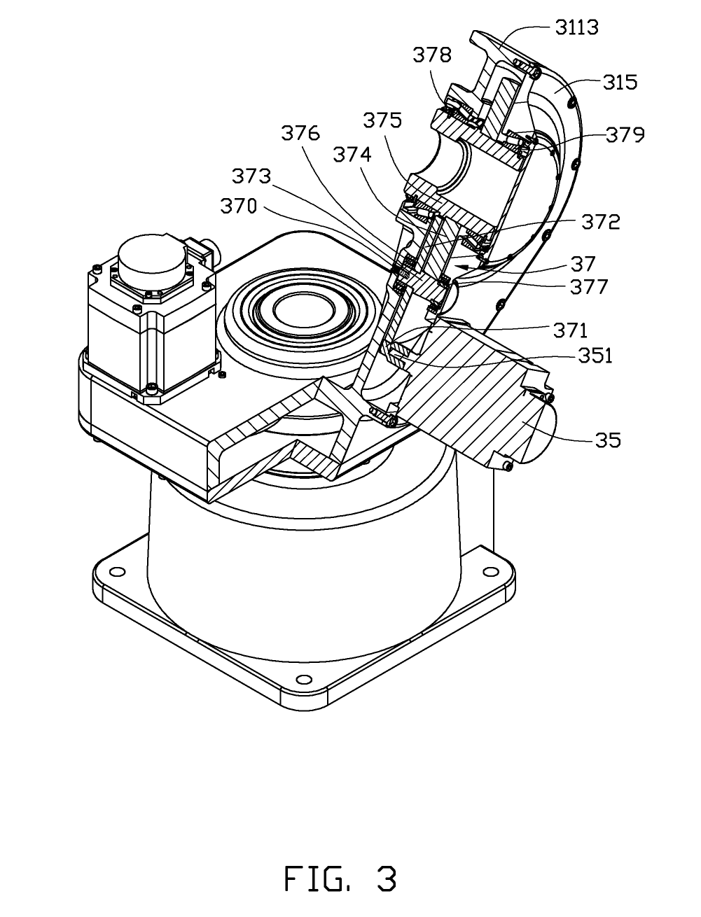

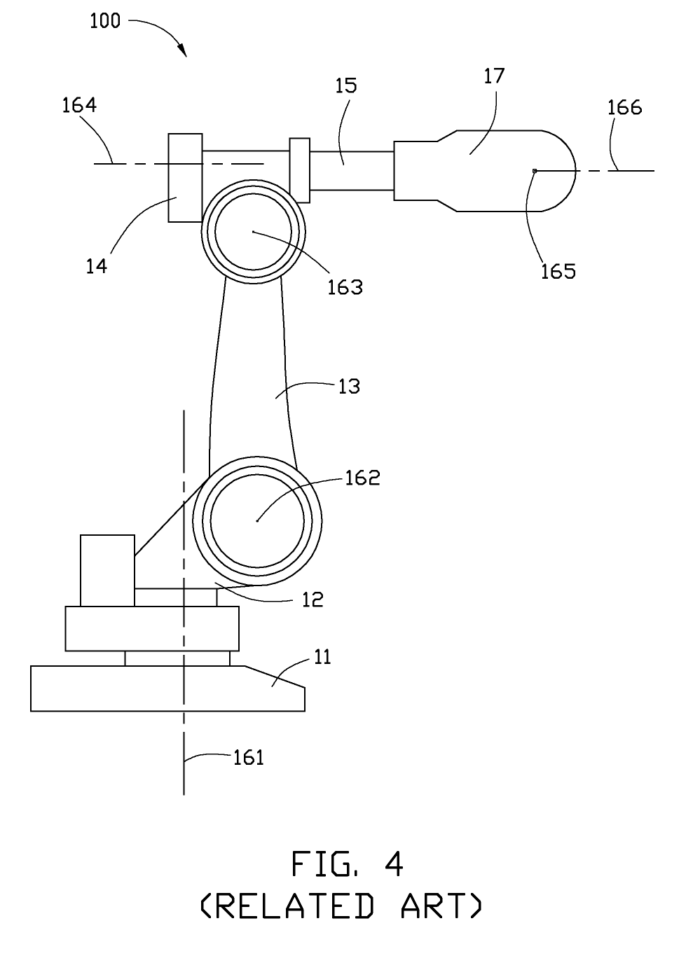

Referring to FIGS. 3 and 4, the robot arm assembly 30 comprises a gear box 31, a first driving member 33, a second driving member 35, a first transmission mechanism 36, and a second transmission mechanism 37. The first transmission mechanism 36 and the second transmission mechanism 37 are positioned in the gear box 31.

The gear box 31 comprises a main body 311, a first cover 313, and a second cover 315. The main body 311 comprises a first box 3111 and a second box 3113 connected to the first box 3111. The first cover 313 is fixed to the first box 3111, and together with the first box 3111 forms a first receiving groove 3115 for receiving the first transmission mechanism 36. The second cover 315 is fixed to the second box 3113, and, with the second box 3113, forms a second receiving groove 3116 for receiving the second transmission mechanism 37. In an illustrated embodiment, the second box 3113 is substantially perpendicularly connected to the first box 3111.

The first driving member 33 is fixed to a top wall of the first box 3111, and the second driving member 35 is fixed to the second cover 315. The first driving member 33 comprises a first driving shaft 331 extending through the top wall of the first box 3111, and the second driving member 35 comprises a second driving shaft 351 extending through the second cover 315. In the illustrated embodiment, the first driving member 33 and the second driving member 35 are servo motors.

The first transmission mechanism 36 comprises a gap adjusting assembly 360, a first gear 361, a second gear 362, a third gear 363, a fourth gear 364, a fixed shaft 365, a first bearing 366, a second bearing 367, a third bearing 368, and a fourth bearing 369. The first gear 361 meshes with the second gear 362. The second gear 362 is fixed to the third gear 363. The third gear 363 meshes with the fourth gear 364. The fourth gear 364 is rotatably sleeved on the fixed shaft 365. The gap adjusting assembly 360 adjusts a gap between the third gear 363 and the fourth gear 364. In the illustrated embodiment, the third gear 363 and the fourth gear 364 are bevel gears.

The first bearing 366 and the third bearing 368 are fixed to the first box 3111. The second bearing 367 and the fourth bearing 369 are fixed to the first cover 313. The first bearing 366 is aligned with the second bearing 367, and the third bearing 368 is aligned with the fourth bearing 369.

The first gear 361 is fixed to the first driving shaft 331. The third gear 363 comprises a gear shaft (not labeled), and the first bearing 366 and the third bearing 368 are positioned on opposite ends of the gear shaft of the third gear 363. The second gear 362 fixedly sleeves on the gear shaft of the third gear 363. The fourth gear 364 is fixed to a bottom wall of the gear box 31. The fixed shaft 365 extends through the third bearing 368 and the fourth bearing 369, and is fixed to the base 20.

The third gear 363 defines a positioning hole 3631 in an end adjacent to the first bearing 366. The gap adjusting assembly 360 comprises an elastic member 3601, a fastener 3603, and a resisting member 3605. The resisting member 3605 and the elastic member 3601 are received in the positioning hole 3631 in that order. The fastener 3603 is fixed on the first box 3111, and abuts against the elastic member 3601. In the illustrated embodiment, the resisting member 3605 is a steel ball, the elastic member 3601 is a compression spring, and the fastener 3603 is a screw. The fastener 3603 can be moved towards the third gear 363 by a screwdriver (not shown), and then the third gear 363 is driven to move by the resisting member 3605, such that the gap between the third gear 363 and the fourth gear 364 decreases, because the third gear 363 and the fourth gear 364 are bevel gears. That is, the third gear 363 can be driven to move to mesh with the fourth gear 364 more tightly by adjusting the fastener 3603.

When the first driving member 33 is working, the first driving shaft 331 drives the first gear 361 to rotate, and then the first gear 361 drives the second gear 362 to rotate. The second gear 362 drives the third gear 363 to rotate on the first bearing 366 and the second bearing 367. The third gear 363 drives the fourth gear 364 to rotate. The gear box 31 rotates about the fixed shaft 365 together with the fourth gear 364 because the fourth gear 364 is fixed to the gear box 31.

In the illustrated embodiment, the first gear 361, the second gear 362, the third gear 363, and the fourth gear 364 are spur involute gears. A rotating axis of the first driving shaft 331, a rotating axis of the second gear 362, and a rotating axis of the fourth gear 364 are substantially parallel to each other. The manufacturing costs of the first gear 361, the second gear 362, the third gear 363, and the fourth gear 364 are relatively low, comparing with the related art speed reducer. Therefore, the industrial robot 200 has a low manufacturing cost. A total reduction ratio of the first transmission mechanism 36 can be adjusted by changing a number of teeth of the first gear 361, the second gear 362, the third gear 363, and the fourth gear 364. For example, a reduction ratio between the first gear 361 and the second gear 362 may be 11, and a reduction ratio between the third gear 363 and the fourth gear 364 may be 5, thus the total reduction ratio of the first transmission mechanism 36 is 55.

In an alternative embodiment, the first transmission mechanism 36 may only comprise the first gear 361 and the fourth gear 364 directly meshing with the first gear 361.

The second transmission mechanism 37 has a similar structure to the first transmission mechanism 36. The second transmission mechanism 37 comprises a gap adjusting assembly 370, a fifth gear 371, a sixth gear 372, a seventh gear 373, an eighth gear 374, an output shaft 375, a fifth bearing 376, a sixth bearing 377, a seventh bearing 378, and an eighth bearing 379. The fifth gear 371 meshes with the sixth gear 372. The sixth gear 372 is fixed to the seventh bearing 378. The seventh bearing 378 meshes with the eighth gear 374, and the eighth gear 374 is fixedly sleeved on the output shaft 375. The gap adjusting assembly 370 of the second transmission mechanism 37 has the same structure as the gap adjusting assembly 360 of the first transmission mechanism 36. The gap adjusting assembly 370 adjusts a gap between the seventh gear 373 and the eighth gear 374.

The fifth bearing 376 and the seventh bearing 378 are fixed to the second box 3113. The sixth bearing 377 and the eighth bearing 379 are fixed to the second cover 315. The fifth bearing 376 aligns with the sixth bearing 377, and the seventh bearing 378 aligns with the eighth bearing 379.

When the second driving member 35 is working, the second driving shaft 351 rotates the fifth gear 371, and the fifth gear 371 rotates the sixth gear 372. The sixth gear 372 rotates the seventh gear 373 on the fifth bearing 376 and the sixth bearing 377. The seventh gear 373 rotates the eighth gear 374. The output shaft 375 rotates on the seventh bearing 378 and the eighth bearing 379 together with the fourth gear 364 because the eighth gear 374 is fixed to the output shaft 375.

In the illustrated embodiment, the fifth gear 371, the sixth gear 372, the seventh gear 373, and the eighth gear 374 are spur involute gears. A rotating axis of the second driving shaft 351, a rotating axis of the sixth gear 372, a rotating axis of the eighth gear 374, and a rotating axis of the output shaft 375 are substantially parallel to each other. The manufacturing costs of the fifth gear 371, the sixth gear 372, the seventh gear 373, and the eighth gear 374 are low, compared with the related art speed reducer. Therefore, the manufacturing cost of the industrial robot 200 is further reduced. A total reduction ratio of the second transmission mechanism 37 can be adjusted by changing a number of teeth of the fifth gear 371, the sixth gear 372, the seventh gear 373, and the eighth gear 374. For example, a reduction ratio between the fifth gear 371 and the sixth gear 372 may be 11, and a reduction ratio between the seventh gear 373 and the eighth gear 374 may be 5, thus the total reduction ratio of the second transmission mechanism 37 is 55.

In an alternative embodiment, the first transmission mechanism 36 may only comprise the fifth gear 371 directly meshed with the eighth gear 374.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A industrial robot comprising a base;
a robot arm assembly rotatably connected to the base; the robot arm assembly comprising:
a gear box;
a first driving member positioned on the gear box, the first driving member having a first driving shaft;
a first transmission mechanism positioned in the gear box, wherein the first transmission mechanism has at least two gears meshing with each other and a fixed shaft fixed to the base, one of the at least two gears is connected to the first driving shaft, and another one of the at least two gears is rotatably sleeved on the fixed shaft, and fixed to the gear box.

2. The industrial robot of claim 1, wherein the gear box comprises a first box and a second box connected to the first box, the first driving member is positioned on the first box.

3. The industrial robot of claim 2, further comprising a second driving member and a second transmission mechanism, wherein the second driving member is positioned on the second box, and has a second driving shaft; the second transmission mechanism comprises at least two gears meshing with each other, one of the at least two gears of the second transmission mechanism is connected to the second driving shaft, and another one of the at least two gears of the second transmission mechanism is fixed to an output shaft rotatably connected to the second box.

4. The industrial robot of claim 3, wherein the first driving member and the second driving members are servo motors.

5. The industrial robot of claim 3, wherein a rotating axis of the second driving shaft is substantially parallel to a rotating axis the output shaft.

6. The industrial robot of claim 1, wherein a rotating axis of the first driving shaft is substantially parallel to a rotating axis of the fixed shaft.

7. The industrial robot of claim 2, wherein the at least two gears of the first transmission mechanism comprises a first gear fixed to the first driving shaft, a second gear meshing with the first gear, a third gear fixed to the second gear, and a fourth gear meshing with the third gear; the fourth gear is rotatably connected to the fixed shaft and fixed to the gear box.

8. The industrial robot of claim 7, wherein the at least two gears of the second transmission mechanism comprises a fifth gear fixed to the second driving shaft, a sixth gear meshing with the fifth gear, a seventh gear fixed to the sixth gear, and an eighth gear meshing with the seventh gear; the eighth gear is fixed to the output shaft.

9. The industrial robot of claim 7, wherein the gear box further a first cover fixed to the first box; a first bearing and a third bearing are fixed to the first box, a second bearing and a fourth bearing are fixed to the first cover; the first bearing is aligned with the second bearing, and the third gear is positioned on the first bearing and the second bearing; the third bearing is aligned with the fourth bearing, and the fixed shaft is positioned on the third bearing and the fourth bearing.

10. The industrial robot of claim 9, wherein the gear box further a second cover fixed to the second box; a fifth bearing and a seventh bearing are fixed to the second box, a sixth bearing and an eighth bearing are fixed to the second cover; the fifth bearing is aligned with the sixth bearing, and the seventh gear is positioned on the fifth bearing and the sixth bearing; the seventh bearing is aligned with the eighth bearing, and the output shaft is positioned on the seventh bearing and the eighth bearing.

11. The industrial robot of claim 7, wherein the third gear and the fourth gear are bevel gear and mesh with each other, an end of the third gear defines a positioning hole, the first transmission further comprises a gap adjusting assembly, the gap adjusting assembly comprises an elastic member, a fastener, and a resisting member; the resisting member and the elastic member are received in the positioning hole of the third gear in that order;
the fastener is fixed on the gear box, and abuts against the elastic member.

12. A industrial robot comprising
a base;
a robot arm assembly rotatably connected to the base; the robot arm assembly comprising:
a gear box;
a first driving member positioned on the gear box, the first driving member having a first driving shaft;
a first transmission mechanism positioned in the gear box, wherein the first transmission mechanism has at least two gears meshing with each other, one of the at least two gears is connected to the first driving shaft, and another one of the at least two gears is fixed to the gear box, the gear box is rotated by the first driving shaft.

13. The industrial robot of claim 12, wherein the gear box comprises a first box and a second box connected to the first box, the first driving member is positioned on the first box.

14. The industrial robot of claim 13, further comprising a second driving member and a second transmission mechanism, wherein the second driving member is positioned on the second box, and has a second driving shaft; the second transmission mechanism comprises at least two gears meshing with each other, one of the at least two gears of the second transmission mechanism is connected to the second driving shaft, and another one of the at least two gears of the second transmission mechanism is fixed to an output shaft rotatably connected to the second box.

15. The industrial robot of claim 14, wherein a rotating axis of the second driving shaft is substantially parallel to a rotating axis the output shaft.

16. The industrial robot of claim 13, wherein the at least two gears of the first transmission mechanism comprises a first gear fixed to the first driving shaft, a second gear meshing with the first gear, a third gear fixed to the second gear, and a fourth gear meshing with the third gear; the fourth gear is rotatably connected to a fixed shaft and fixed to the gear box.

17. The industrial robot of claim 16, wherein a rotating axis of the first driving shaft is substantially parallel to a rotating axis of the fixed shaft.

18. The industrial robot of claim 16, wherein the at least two gears of the second transmission mechanism comprises a fifth gear fixed to the second driving shaft, a sixth gear meshing with the fifth gear, a seventh gear fixed to the sixth gear, and an eighth gear meshing with the seventh gear; the eighth gear is fixed to the output shaft.

19. The industrial robot of claim 16, wherein the gear box further a first cover fixed to the first box; a first bearing and a third bearing are fixed to the first box, a second bearing and a fourth bearing are fixed to the first cover; the first bearing is aligned with the second bearing, and the third gear is positioned on the first bearing and the second bearing; the third bearing is aligned with the fourth bearing, and the fixed shaft is positioned on the third bearing and the fourth bearing.

20. The industrial robot of claim 19, wherein the gear box further a second cover fixed to the second box; a fifth bearing and a seventh bearing are fixed to the second box, a sixth bearing and an eighth bearing are fixed to the second cover; the fifth bearing is aligned with the sixth bearing, and the seventh gear is positioned on the fifth bearing and the sixth bearing; the seventh bearing is aligned with the eighth bearing, and the output shaft is positioned on the seventh bearing and the eighth bearing.
